(19) United States
(12) Patent Application Publication
(10) Pub. No.: US 2022/0113575 A1
(43) Pub. Date: Apr. 14, 2022

(54) COLOR FILTER SUBSTRATE, DISPLAY PANEL, AND ELECTRONIC DEVICE

(71) Applicant: WUHAN CHINA STAR OPTOELECTRONICS TECHNOLOGY CO., LTD., Wuhan, Hubei (CN)

(72) Inventor: Guizhi MA, Wuhan, Hubei (CN)

(73) Assignee: WUHAN CHINA STAR OPTOELECTRONICS TECHNOLOGY CO., LTD., Wuhan, Hubei (CN)

(21) Appl. No.: 16/770,968

(22) PCT Filed: Apr. 10, 2020
(86) PCT No.: PCT/CN2020/084197

§ 371 Date: Jun. 9, 2020

(30) Foreign Application Priority Data
Mar. 26, 2020 (CN) 2020 10226006.6

(51) Int. Cl. G02F 1/1339; G02F 1/1335

(52) U.S. Cl. CPC G02F 1/13394; G02F 1/133514; G02F 1/13398; G02F 1/13396; G02F 1/133512

(57) ABSTRACT

The present invention provides a color filter substrate, a display panel, and an electronic device. The color filter substrate includes a preset region, a display region, and a light-shielding region. The light-shielding region is provided with spacers. The light-shielding region includes a first sub-region and a second sub-region. A deformation amount of the first sub-region is greater than a deformation amount of the second sub-region when the color filter substrate is pressed. The color filter substrate, the display panel, and the electronic device of the present invention can increase a resolution and photographing effect of an under-screen camera.

### FIELD OF INVENTION

The present invention is related to the field of display technology, and specifically, to a color filter substrate, a display panel, and an electronic device.

### BACKGROUND OF INVENTION

Currently, a camera is placed under a display panel with a blind hole provided at a position corresponding thereto, and light enters the camera through the blind hole during photographing. However, because a surface flatness of the display panel cannot be same as that of glass, which means the surface flatness of the display panel and uniformity a liquid crystal cell is poor, photographing effect is affected, thereby decreasing a resolution and the photographing effect of an under-screen camera.

### SUMMARY OF INVENTION

Because a surface flatness of a display panel cannot be same as that of glass, which means the surface flatness of the display panel and uniformity a liquid crystal cell being poor, photographing effect is affected, thereby decreasing a resolution and the photographing effect of an under-screen camera.

A purpose of the present invention is to provide a color filter substrate, a display panel, and an electronic device, so as to increase the resolution and the photographing effect of the under-screen camera.

In order to achieve the above purpose, the color filter substrate provided by the present invention includes:

a preset region for disposing a camera;

a display region for displaying images; and

a light-shielding region disposed between the preset region and the display region and provided with spacers; wherein the light-shielding region includes a first sub-region and a second sub-region, the first sub-region is defined on a side of the preset region, and the second sub-region is defined on another side of the preset region; and wherein a deformation amount of the first sub-region is greater than a deformation amount of the second sub-region when the color filter substrate is pressed.

The present invention provides the display panel including the color filter substrate;

the color filter substrate includes:

a preset region for disposing a camera;

a display region for displaying images; and

a light-shielding region disposed between the preset region and the display region and provided with spacers; wherein the light-shielding region includes a first sub-region and a second sub-region, the first sub-region is defined on a side of the preset region, and the second sub-region is defined on another side of the preset region; and wherein a deformation amount of the first sub-region is greater than a deformation amount of the second sub-region when the color filter substrate is pressed.

The present invention further provides the electronic device including the display panel; the display panel includes the color filter substrate;

the color filter substrate includes:

a preset region for disposing a camera;

a display region for displaying images; and

a light-shielding region disposed between the preset region and the display region and provided with spacers; wherein the light-shielding region includes a first sub-region and a second sub-region, the first sub-region is defined on a side of the preset region, and the second sub-region is defined on another side of the preset region; and wherein a deformation amount of the first sub-region is greater than a deformation amount of the second sub-region when the color filter substrate is pressed.

The color filter substrate, the display panel, and the electronic device of the present invention include: the preset region for disposing the camera; the display region for displaying the images; and the light-shielding region disposed between the preset region and the display region and provided with the spacers. The light-shielding region includes the first sub-region and the second sub-region. The first sub-region is defined on the side of the preset region. The second sub-region is defined on another side of the preset region. The deformation amount of the first sub-region is greater than the deformation amount of the second sub-region when the color filter substrate is pressed. Because the deformation amount of the first sub-region is greater than the deformation amount of the second sub-region when the color filter substrate is pressed, a position of the greatest deformation amount offsets from the preset region to the first sub-region. This increases uniformity of a thickness of the preset region, thereby increasing the resolution and the photographing effect of the under-screen camera.

### DESCRIPTION OF DRAWINGS

FIG. 1 is a schematic diagram of distribution of spacers in a light-shielding region of a prior art color filter substrate.

FIG. 2 is a structural diagram corresponding to FIG. 1.

FIG. 3 is a schematic diagram of distribution of spacers in a light-shielding region of a color filter substrate of the present invention.

FIG. 4 is a first cross-sectional view of the color filter substrate of the present invention.

FIG. 5 is a second cross-sectional view of the color filter substrate of the present invention.

FIG. 6 is a third cross-sectional view of the color filter substrate of the present invention.

### DETAILED DESCRIPTION OF PREFERRED EMBODIMENTS

Examples are described below with reference to the appended drawings, and the drawings illustrate particular embodiments in which the present invention may be practiced. Directional terms mentioned in the present invention, such as upper, lower, front, rear, left, right, in, out, side, etc., only refer to directions in the accompanying drawings. Thus, the adoption of directional terms is used to describe and understand the present invention, but not to limit the present invention. In the drawings, units of similar structures are using the same numeral to represent.

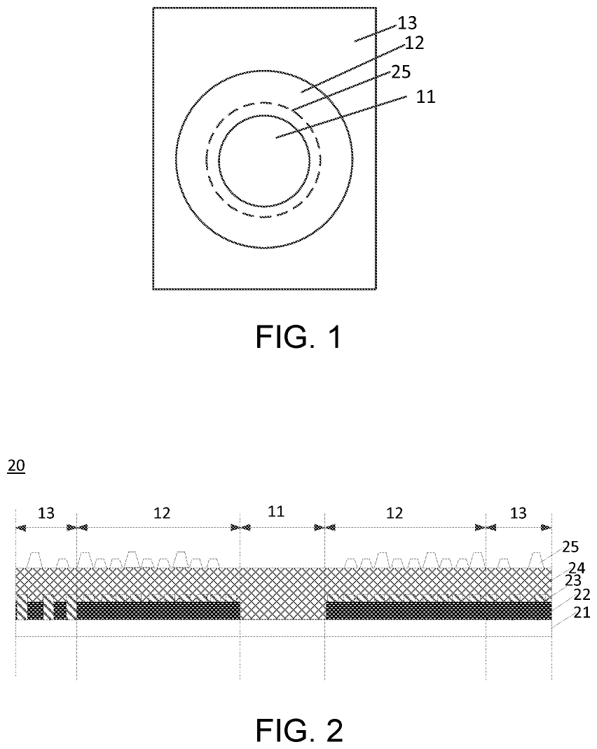

Please refer to FIGS. 1 and 2. FIG. 1 is a schematic diagram of distribution of spacers in a light-shielding region of a prior art color filter substrate.

For example, as shown in FIGS. 1 and 2, the prior art color filter substrate includes a preset region 11 and a light-shielding region 12 and a display region 13 sequentially disposed outside the preset region 11.

A camera is provided under the preset region 11.

As shown in FIG. 2, a cross-sectional structure of a color filter substrate 20 includes a base substrate 21 and a black matrix 22, a color filter layer 23, a planarization layer 24, and spacers 25 sequentially disposed on the base substrate 21. With reference to FIG. 1, a dashed line in FIG. 1 indicates the spacers 25 which are closest to the preset region 11 in the light-shielding region 12. It can be seen that the spacers 25 in the light-shielding region 12 on a left side and a right side of the preset region 11 are symmetrically disposed relative to the preset region 11. In other words, in the prior art color filter substrate, deformation amounts of the light-shielding region 12 on the left side and the right side of the preset region 11 are a same.

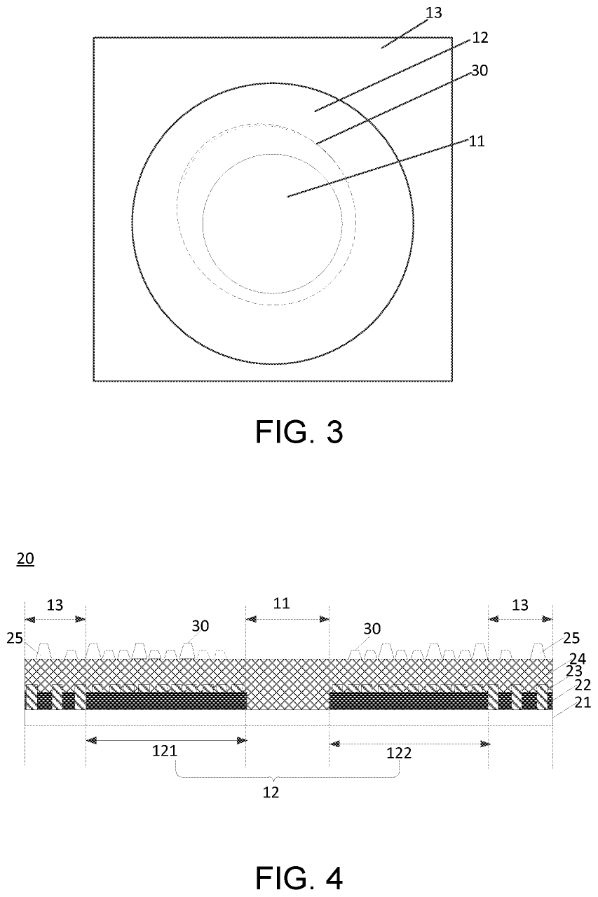

Please refer to FIGS. 3 and 6. FIG. 3 is a schematic diagram of distribution of spacers in a light-shielding region of a color filter substrate of the present invention.

As shown in FIGS. 3 and 4, the color filter substrate 20 of the present invention includes a preset region 11, a light-shielding region 12, and a display region 13.

The preset region 11 is used to dispose a camera (not shown). In an embodiment, the preset region 11 is not provided with a light-shielding layer and a color filter layer. A cross-sectional structure of the preset region 11 includes a base substrate 21 and a planarization layer 24. In an embodiment, the planarization layer 24 is a transparent material in order to increase transmission effect of the preset region.

The display region 13 is used to display images. In an embodiment, a cross-sectional structure of the display region 13 includes the base substrate 21, a black matrix 22, the color filter layer 23, the planarization layer 24, and spacers 25. The black matrix in the display region 13 is arranged at intervals. The spacers 25 correspond to positions of the black matrix.

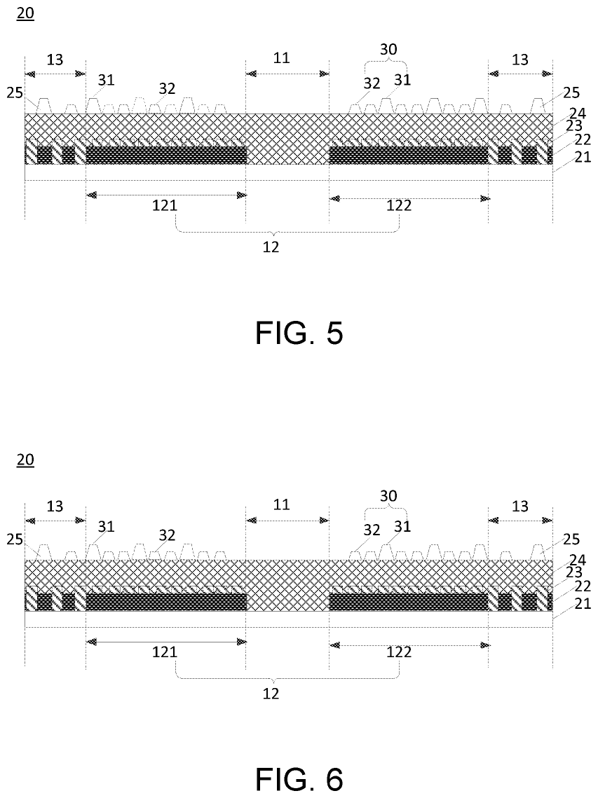

The light-shielding region 12 is disposed between the preset region 11 and the display region 13. The light-shielding region 12 is provided with the spacers 30. The light-shielding region 12 includes a first sub-region 121 and a second sub-region 122. The first sub-region 121 is defined on a side of the preset region 11. The second sub-region 122 is defined on another side of the preset region 11. A deformation amount of the first sub-region 121 is greater than a deformation amount of the second sub-region 122 when the color filter substrate 20 is pressed. In an embodiment, a cross-sectional structure of the light-shielding region 12 includes the base substrate 21, the black matrix 22, the color filter layer 23, the planarization layer 24, and the spacers 30. With reference to FIGS. 5 and 6, the spacers 30 include primary spacers 31 and secondary spacers 32. The black matrix in the display region 13 is not arranged at intervals. Positions of the spacers 30 are not limited. In an embodiment, the light-shielding region 12 surrounds the preset region 11. Of course, the light-shielding region 12 can also partially surround the preset region 11. The black matrix in the display region 13 is used as a light-shielding layer, and material thereof may not be limited to black photoresist.

In an embodiment, in order to simplify manufacturing processes and further reduce a peak-to-valley ratio of the preset region, wherein the lesser the peak-to-valley ratio is, the better photographing quality is, an arrangement density of the spacers 30 in the first sub-region 121 is less than an arrangement density of the spacers 30 in the second sub-region 122. As shown in FIG. 4, for example, to further simplify the manufacturing processes, the arrangement density of the spacers 30 in the first sub-region 121 near the preset region 11 is less than the arrangement density of the spacers 30 in the second sub-region 122 near the preset region 11. The arrangement density of the spacers 30 on a right side of the first sub-region 121 is less than the arrangement density of the spacers 30 on a left side of the second sub-region 122. The arrangement density of the spacers 30 on a left side of the first sub-region 121 can be equal to the arrangement density of the spacers 30 on a right side of the second sub-region 122.

In an embodiment, as shown in FIG. 4, a distance between the spacers 30 in the first sub-region 121 and the preset region 11 is greater than a distance between the spacers 30 in the second sub-region 122 and the preset region 11. For example, the spacers in the first sub-region 121 near the preset region are removed (as the spacers indicated by a dashed line in the figure), and the spacers 30 in the second sub-region 122 remain unchanged, which is same as that in the prior art. With reference to FIG. 3, a dashed line in FIG. 3 indicates the spacers 30 which surround the preset region 11 and are closest to the preset region 11.

In an embodiment, as shown in FIG. 5, a distance between two adjacent spacers 30 in the first sub-region 121 is greater than a distance between two adjacent spacers 30 in the second sub-region 122. In an embodiment, the two adjacent spacers 30 in the first sub-region 121 can be removed. In FIGS. 4 to 6, a dashed trapezoid indicates the removed spacers, thereby increasing the distance, and the distance between the two adjacent spacers 30 in the second sub-region 122 remain unchanged, which is same as that in the prior art. Of course, methods of changing the distance between the two adjacent spacers in the first sub-region are not limited herein. Understandably, cross-sectional shapes of the spacers are not limited herein.

In an embodiment, as shown in FIG. 6, in order to further increase the photographing quality, a number of the primary spacers 31 in the first sub-region 121 is less than a number of the primary spacers 31 in the second sub-region 122. In another embodiment, the first sub-region 121 is provided with the primary spacers 31, and the second sub-region 122 is provided with the primary spacers 31 and the secondary spacers 32. In another embodiment, with reference to FIG. 5. a number of the secondary spacers 32 in the first sub-region 121 is less than a number of the secondary spacers 32 in the second sub-region 122.

In another embodiment, a height of the primary spacers 31 in the first sub-region 121 can be less than a height of the primary spacers 31 in the second sub-region 122. A height difference between the two can be configured according to requirements.

In an embodiment, a deformation amount of the spacers 30 in the first sub-region 121 is greater than a deformation amount of the spacers 30 in the second sub-region 122 when the color filter substrate is pressed. For example, the spacers 30 in the first sub-region 121 can be made of a flexible material, and the spacers 30 in the second sub-region 121 can be made of a non-flexible material. Types of the flexible material can be selected according to requirements and are not limited herein.

Understandably, the first sub-region can be a part of the light-shielding region or a region on a side or two sides of the preset region 11, for example, the first sub-region can be defined on a top side and a left side of the preset region 11, and of course, the first sub-region is not limited herein. In another embodiment, the deformation amounts of the first sub-region and the second sub-region can be changed by changing thicknesses or materials of other film layers in the first sub-region and the second sub-region, and the specific configuration method is not limited herein.

The present invention further provides a display panel including any one of the above color filter substrates, and can further include an array substrate. In an embodiment, the array substrate can be provided without the spacers.

The present invention further provides an electronic device including the above display panel.

Because the deformation amount of the first sub-region is greater than the deformation amount of the second sub-region when the color filter substrate is pressed, a position of the greatest deformation amount offsets from the preset region to the first sub-region. This increases uniformity of a thickness of the preset region, thereby increasing the resolution and the photographing effect of the under-screen camera.

The color filter substrate, the display panel, and the electronic device of the present invention include: the preset region for disposing the camera; the display region for displaying the images; and the light-shielding region disposed between the preset region and the display region and provided with the spacers. The light-shielding region includes the first sub-region and the second sub-region. The first sub-region is defined on the side of the preset region. The second sub-region is defined on another side of the preset region. The deformation amount of the first sub-region is greater than the deformation amount of the second sub-region when the color filter substrate is pressed. Because the deformation amount of the first sub-region is greater than the deformation amount of the second sub-region when the color filter substrate is pressed, the position of the greatest deformation amount offsets from the preset region to the first sub-region. This increases uniformity of the thickness of the preset region, thereby increasing the resolution and the photographing effect of the under-screen camera.

Although the present invention has been disclosed above with the preferred embodiments, it is not intended to limit the present invention. Persons having ordinary skill in this technical field can still make various alterations and modifications without departing from the scope and spirit of this invention. Therefore, the scope of the present invention should be defined and protected by the following claims and their equivalents.

What is claimed is:

1. A color filter substrate, comprising:
a preset region for disposing a camera;
a display region for displaying images; and
a light-shielding region disposed between the preset region and the display region and provided with spacers;
wherein the light-shielding region comprises a first sub-region and a second sub-region, the first sub-region is defined on a side of the preset region, and the second sub-region is defined on another side of the preset region; and
wherein a deformation amount of the first sub-region is greater than a deformation amount of the second sub-region when the color filter substrate is pressed.

2. The color filter substrate according to claim 1, wherein an arrangement density of the spacers in the first sub-region is less than an arrangement density of the spacers in the second sub-region.

3. The color filter substrate according to claim 1, wherein an arrangement density of the spacers in the first sub-region near the preset region is less than an arrangement density of the spacers in the second sub-region near the preset region.

4. The color filter substrate according to claim 1, wherein a distance between the spacers in the first sub-region and the preset region is greater than a distance between the spacers in the second sub-region and the preset region.

5. The color filter substrate according to claim 1, wherein a distance between two adjacent spacers in the first sub-region is greater than a distance between two adjacent spacers in the second sub-region.

6. The color filter substrate according to claim 1, wherein the spacers comprise primary spacers and secondary spacers; and
a number of the primary spacers in the first sub-region is less than a number of the primary spacers in the second sub-region.

7. The color filter substrate according to claim 6, wherein a number of the secondary spacers in the first sub-region is less than a number of the secondary spacers in the second sub-region.

8. The color filter substrate according to claim 1, wherein the spacers comprise primary spacers and secondary spacers; and
a height of the primary spacers in the first sub-region is less than a height of the primary spacers in the second sub-region.

9. A display panel, comprising a color filter substrate;
wherein the color filter substrate comprises:
a preset region for disposing a camera;
a display region for displaying images; and
a light-shielding region disposed between the preset region and the display region and provided with spacers;
wherein the light-shielding region comprises a first sub-region and a second sub-region, the first sub-region is defined on a side of the preset region, and the second sub-region is defined on another side of the preset region; and
wherein a deformation amount of the first sub-region is greater than a deformation amount of the second sub-region when the color filter substrate is pressed.

10. The display panel according to claim 9, wherein an arrangement density of the spacers in the first sub-region is less than an arrangement density of the spacers in the second sub-region.

11. The display panel according to claim 9, wherein an arrangement density of the spacers in the first sub-region near the preset region is less than an arrangement density of the spacers in the second sub-region near the preset region.

12. The display panel according to claim 9, wherein a distance between the spacers in the first sub-region and the preset region is greater than a distance between the spacers in the second sub-region and the preset region.

13. The display panel according to claim 9, wherein a distance between two adjacent spacers in the first sub-region is greater than a distance between two adjacent spacers in the second sub-region.

14. The display panel according to claim 9, wherein the spacers comprise primary spacers and secondary spacers; and
a number of the primary spacers in the first sub-region is less than a number of the primary spacers in the second sub-region.

15. The display panel according to claim 14, wherein a number of the secondary spacers in the first sub-region is less than a number of the secondary spacers in the second sub-region.

16. The display panel according to claim 9, wherein the spacers comprise primary spacers and secondary spacers; and
a height of the primary spacers in the first sub-region is less than a height of the primary spacers in the second sub-region.

17. An electronic device, comprising a display panel;
wherein the display panel comprises a color filter substrate, and the color filter substrate comprises:
a preset region for disposing a camera;
a display region for displaying images; and
a light-shielding region disposed between the preset region and the display region and provided with spacers;
wherein the light-shielding region comprises a first sub-region and a second sub-region, the first sub-region is defined on a side of the preset region, and the second sub-region is defined on another side of the preset region; and
wherein a deformation amount of the first sub-region is greater than a deformation amount of the second sub-region when the color filter substrate is pressed.
